(19) United States
(12) Patent Application Publication
(10) Pub. No.: US 2026/0183591 A1
(43) Pub. Date: Jul. 2, 2026

(54) FIRE EXTINGUISHING SYSTEM AND METHOD USING HIGH STORED ENERGY

(71) Applicant: Government of the United States, as represented by the Secretary of the Army, Washington, DC (US)

(72) Inventors: Joshua Ryan Fritsch, Beverly Hills, MI (US); James Brian Slemons, Davisburg, MI (US); Steven Edward Hodges, Eugene, OR (US); Steven James McCormick, Macomb, MI (US); John Wright Porterfield, JR., Rolesville, NC (US)

(73) Assignee: Government of the United States, as represented by the Secretary of the Army, Washington, DC (US)

(21) Appl. No.: 19/283,339

(22) Filed: Jul. 29, 2025

Related U.S. Application Data
(60) Provisional application No. 63/678,290, filed on Aug. 1, 2024.

(51) Int. Cl. A62C 35/02; A62C 3/07; A62C 35/13

(52) U.S. Cl. CPC A62C 35/023; A62C 3/07; A62C 35/13

(57) ABSTRACT

A fire extinguishing system and method includes a pressure vessel and a control module. The pressure vessel is charged with a predetermined mixture to a stored energy of greater than 100 bar*L/kg. The predetermined mixture includes a propellant gas and a fire extinguishing agent. The control module is configured to fully discharge the pressure vessel to a protected compartment in response to a fire threat detected in the protected compartment by at least one sensor in communication with the control module.

### GOVERNMENT INTEREST

The embodiments described herein may be manufactured, used, and/or licensed by or for the Government of the United States of America without payment by the Government of any royalties thereon.

### TECHNICAL FIELD

The present disclosure relates to a fire extinguishing system and method.

### BACKGROUND

The statements in this section merely provide background information related to the present disclosure and may not constitute prior art.

Halogenated hydrocarbons (halons), particularly halon 1301 (CF₃Br), have been widely used in commercial, industrial, and military fire protection applications since the 1960s due to fire extinguishing effectiveness, low toxicity, and no need for cleanup. Hydrofluorocarbons (HFC) began replacing halons in the 1990s following implementation of the Montreal Protocol on Substances that Deplete the Ozone Layer which phased out production of halons and other ozone-depleting substances (ODS). The 2016 Kigali Amendment to the Montreal Protocol and the 2020 American Innovation and Manufacturing (AIM) Act have begun to impact the availability of HFCs due to their high global warming potential (GWP) which necessitates research and testing to identify safe and technically feasible replacements.

Protecting occupants of military vehicles presents unique challenges as the automatic fire extinguishing system (AFES) must extinguish hydrocarbon fuel fires or explosions without injuring the crew and maintain a habitable environment long enough for the crew to egress safely. To accomplish this, the AFES must rapidly detect a fire threat, safely discharge fire extinguishing agent at a high rate, effectively extinguish fires within fractions of a second, and maintain a safe environment within the occupied compartment after agent discharge.

Other potential applications where this approach may be effective against explosive fires that may occur in occupied or unoccupied spaces include oil and gas refineries, aerosol can fill rooms, grain processing facilities, etc.

Alternatives to halons and HFC-based gaseous agents have been investigated and dry chemical fire extinguishing agents have been found to be one of the best performing classes of agents. A dry chemical fire extinguishing agent is comprised of small particles (e.g., sodium bicarbonate or potassium bicarbonate) that extinguish fires by interrupting the fire's chemical chain reaction and absorption of heat. Dry chemical agents are very efficient at fire extinguishing on a mass basis and have zero GWP and Ozone Depletion Potential (ODP). These agents also do not produce toxic decomposition byproducts such as HF, HBr, or COF₂ like HFCs or halons do.

However, dry chemical agents have historically shown reduced effectiveness at preventing reflashes when compared to gaseous agents, especially when applied in cluttered areas, e.g., vehicle compartments with many objects and/or people that can inhibit distribution of the dry chemical agent. As a solid particle, the dry chemical agent has no internal energy and therefore does not efficiently fill a cluttered area to extinguish a fire as gaseous agents would.

The invention of the present disclosure remedies these and other issues associated with the known fire extinguishing systems by providing an improved fire extinguishing system and method.

### SUMMARY OF THE INVENTION

This section provides a general summary of the disclosure and is not a comprehensive disclosure of its full scope or all of its features.

According to one form, the present disclosure provides for A fire extinguishing system includes a pressure vessel and a control module. The pressure vessel is charged with a predetermined mixture to a stored energy of greater than 100 bar*L/kg. The predetermined mixture includes a propellant gas and a fire extinguishing agent. The control module is configured to fully discharge the pressure vessel to a protected compartment in response to a fire threat detected in the protected compartment by at least one sensor in communication with the control module.

In variations of the fire extinguishing system of the above paragraph, which may be implemented individually or in any combination: the fire extinguishing system further includes a valve coupled for fluid communication with an outlet of the pressure vessel, wherein the controller is configured to change the valve from a closed state to an open state to fully discharge the pressure vessel to the protected compartment in response to the fire threat detected in the protected compartment by the at least one sensor; the fire extinguishing system further includes a conduit in fluid communication with the outlet of the pressure vessel and configured to convey the fire extinguishing agent to the protected compartment; the fire extinguishing system further includes the protected compartment, wherein the protected compartment is an occupant compartment of a vehicle; a ratio of the fire extinguishing agent in the predetermined mixture to a total free air volume of the protected compartment is within the range from 20 g/m³ to 300 g/m³; the fire extinguishing agent is a dry chemical agent; the fire extinguishing agent consists essentially of sodium bicarbonate, potassium bicarbonate, or a combination of sodium bicarbonate and potassium bicarbonate; the dry chemical agent has an average particle size less than or equal to 36 μm; the predetermined mixture consists of the propellant gas and the fire extinguishing agent, wherein the propellant gas consists essentially of inert gas, wherein the fire extinguishing agent is a dry chemical agent consisting essentially of sodium bicarbonate, potassium bicarbonate, or a combination of sodium bicarbonate and potassium bicarbonate; the propellant gas consists essentially of inert gas; the stored energy is greater than 1,000 bar*L/kg; the pressure vessel has an internal volume in the range of 0.9 L to 6 L.

In another form, the present disclosure provides a fire extinguishing system includes a pressure vessel, at least one sensor, and a control module. The pressure vessel is charged with a predetermined mixture to a stored energy of greater than 100 bar*L/kg. The predetermined mixture consisting of a propellant gas and a dry chemical agent. The control module is configured to fully discharge the pressure vessel to a protected compartment in response to a fire threat detected in the protected compartment by the at least one sensor.

In variations of the fire extinguishing system of the above paragraph, which may be implemented individually or in any combination: the propellant gas consists essentially of inert gas, wherein the dry chemical agent is a powder that consists essentially of sodium bicarbonate, potassium bicarbonate, or a combination of sodium bicarbonate and potassium bicarbonate; the dry chemical agent has an average particle size less than or equal to 36 μm; the fire extinguishing system further includes the protected compartment, wherein the protected compartment is an occupant compartment of a vehicle, and wherein a ratio of the dry chemical agent in the predetermined mixture to a total free air volume of the protected compartment is less than or equal to 300 g/m³; the stored energy is greater than 1,000 bar*L/kg.

In still another form, the present disclosure provides a method of extinguishing fire in a protected compartment. The method includes charging a pressure vessel with a predetermined mixture to a stored energy of greater than 100 bar*L/kg, the predetermined mixture including a propellant gas and a fire extinguishing agent. The method includes detecting a fire threat using at least one sensor. The method includes fully discharging the pressure vessel to the protected compartment in response to the fire threat being detected by the at least one sensor.

In variations of the method of the above paragraph, which may be implemented individually or in any combination: the predetermined mixture consists of the propellant gas and the fire extinguishing agent, wherein the fire extinguishing agent is a dry chemical agent, wherein the propellant gas consists essentially of inert gas, wherein the dry chemical agent consists essentially of sodium bicarbonate, potassium bicarbonate, or a combination of sodium bicarbonate and potassium bicarbonate; the stored energy is greater than or equal to 1,000 bar*L/kg.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present invention is described with respect to the following figures, wherein like reference numbers indicate substantially similar elements:

FIG. 1 is a schematic view of an example fire extinguishing system, in accordance with the present disclosure;

FIG. 2 is a schematic view showing a pressure vessel of the fire extinguishing system of FIG. 1 in a fully charged state compared to a second pressure vessel that is also fully charged to an equivalent pressure but is charged with a greater amount of a fire extinguishing agent, to illustrate principles of the present invention;

FIG. 3 is a graph illustrating NaHCO₃ fire out times versus stored energy (SE) at various agent design concentrations, to illustrate principles of the present invention;

FIG. 4 is a schematic view of two pressure vessels charged with a similar mass of fire extinguishing agent but with different total pressure vessel volumes and, thus, one of the pressure vessels having low SE and the other having high SE, to illustrate principles of the present invention;

FIG. 5 is a visualization illustrating the discharge pattern of the pressure vessel of FIG. 4 that has low SE, to illustrate principles of the present invention;

FIG. 6 is a visualization illustrating the discharge pattern of the pressure vessel of FIG. 4 that has high SE, to illustrate principles of the present invention;

FIG. 7 is a graph illustrating SE versus fire extinguishing agent concentration discharged into a protected space for successful fire extinguishment, to illustrate principles of the present invention; and

FIG. 8 is a graph showing the difference in particle distribution between new dry chemical agent and dry chemical agent discharged under high SE, to illustrate principles of the present invention.

The drawings described herein are for illustration purposes only and are not intended to limit the scope of the present disclosure in any way.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention. In other instances, particulars of well-known components and manufacturing practices have been omitted so as to avoid unnecessarily obscuring the present invention. It should be understood that throughout the drawings, corresponding reference numerals indicate like or corresponding parts and features.

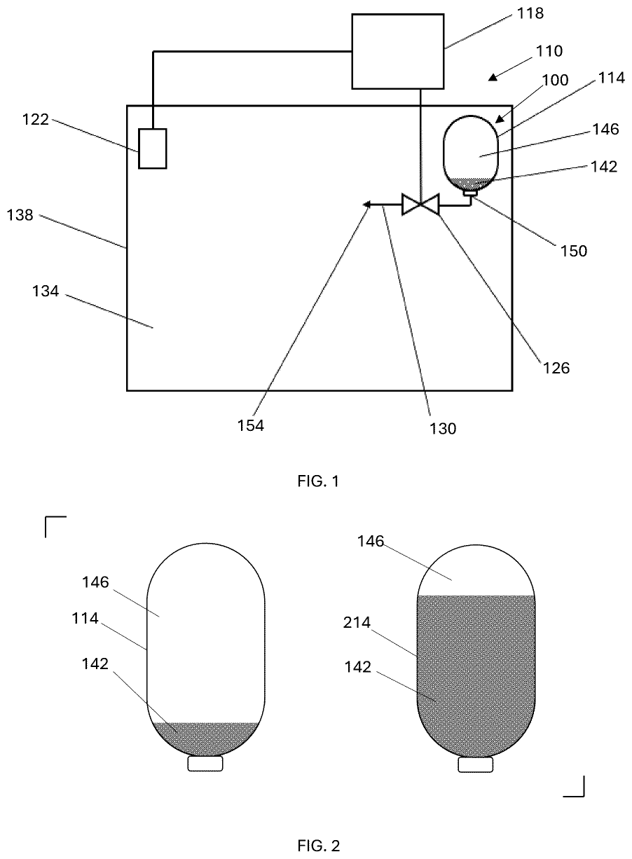

Referring to FIG. 1, a fire extinguishing system 110 is schematically shown. The fire extinguishing system 110 includes a pressure vessel 114 and a control module 118. The fire extinguishing system 110 can also include one or more sensors 122, a valve 126, and a conduit 130 that opens into a protected compartment 134 defined by a structure 138. The pressure vessel 114, valve 126, and conduit 130 is collectively referred to herein as a fire extinguisher 100. The protected compartment 134 is an enclosed or substantially enclosed space defined by the structure 138. In the example provided, the protected compartment 134 is sufficiently sized for one or more adult human occupants (not shown) to be therein, though other configurations may be used. In the example provided, the structure 138 is a vehicle and the protected compartment 134 is an occupant compartment of the vehicle. As such, the structure 138 is also referred to herein as the vehicle 138. The vehicle 138 may be any suitable type of vehicle, including a military or civilian ground vehicle, aircraft, or watercraft, for example. In an alternative configuration, the structure 138 may be a non-vehicular structure and the protected compartment 134 is an enclosed space therein, such as a room in a building, for example. Some such examples may include a room in which explosive materials are handled, such as an aerosol can filling room, oil and gas facilities, or grain or other explosive dust facilities.

In the example provided, the pressure vessel 114 is located within the protected compartment 134. In an alternative form, not specifically shown, the pressure vessel 114 may be located remotely, e.g., outside the protected compartment 134. The fire extinguisher 100 is charged with a fire extinguishing agent 142 (also referred to herein as the agent 142) and pressurized with a propellant gas 146 (also referred to herein as a charging gas or pressurizing gas), as discussed in greater detail below. In other words, the pressure vessel 114 is configured to hold the agent 142 and the propellant gas 146 in the same internal volume of the pressure vessel 114 at a pressure elevated above the pressure (e.g., atmospheric pressure) of the protected compartment 134. In the example provided, the agent 142 is a dry chemical agent (e.g., a powder).

An outlet 150 of the pressure vessel 114 is in fluid communication with the valve 126. The valve 126 is configured to be operated in a closed state to maintain the agent 142 and the propellant gas 146 under pressure in the pressure vessel 114 and to be selectively changed to an open state to rapidly release the agent 142 and the propellant gas 146. The valve 126 may be directly coupled to the outlet 150 or a portion of the conduit 130 may couple the pressure vessel 114 to the valve 126. The valve 126 can be any suitable type of valve that can be selectively and rapidly opened by a signal from the control module 118, such as a solenoid or squib valve, for example.

The valve 126 is located proximate to the bottom of the pressure vessel 114 such that when fully charged and installed (i.e., mounted for use), the pressurized propellant gas 146 will force the solid agent 142 through the outlet 150. In the example provided, the outlet 150 is located through the bottom of the pressure vessel 114. In other configurations, not specifically shown, the outlet 130 may be through the side of the pressure vessel 114, but still proximate the bottom. In still other configurations, the outlet 150 may be located anywhere and a siphon tube (not shown) may extend from the outlet to a position in the internal volume of the pressure vessel 114 such that the solid agent 142 will be pushed through the siphon tube before exiting the outlet 150. Other attitude insensitive configurations may be used.

The control module 118 may also be referred to as a controller. The sensor(s) 122 and the fire extinguisher(s) 100 are in communication with the control module 118, such as through wired or wireless connections for example. The sensor(s) 122 are configured to detect inputs indicative of fire (e.g., heat, light (visible, ultraviolet, and/or infrared), sound, smoke or chemical detection, or any other suitable input or combination of inputs). The control module 118 is configured to determine that a fire is present or imminent and send a control signal to the valve 126 to open the valve 126 to fully discharge the fire extinguisher(s) 100 in response. It should be noted that the fire extinguisher 100 is configured such that a detection of fire causes a single, rapid discharge event that causes the pressure vessel's 114 pressure to equalize with the pressure of the protected compartment 134 and release effectively all of the agent 142 from the pressure vessel 114. Generally, this discharge event can release effectively all of the agent within 200 ms or less. The control signal may also be manually activated, such as by an operator (not shown) pushing a button (not shown) for example, such that the control module 118 sends the control signal in response to the manual activation. Alternatively, the control signal may also be via a mechanical linkage (not specifically shown) independent of the control module 118.

The conduit 130 is in fluid communication with the valve 126 and configured to convey the agent 142 and the propellant gas 146 to one or more specific locations within the protected compartment 134, such as a location remote from the pressure vessel 114. One or more outlets 154 of the conduit 130 are opened to the protected compartment 134. The outlet 154 may define a nozzle configured to direct the spray pattern of the agent 142 into the protected compartment 134. While only one outlet 154 is schematically shown, the conduit 130 may be part of a distribution system that has multiple branches of conduits (and/or manifolds) with outlets located at different locations within the protected compartment 134 to direct the injection of the agent 142 toward more than one location within the protected compartment 134 upon changing the valve 126 to the open state. The conduit 130 may be made up of any type of conduit suitable for distributing the fire extinguishing agent 142 from the pressure vessel 114 to the protected compartment 134, such as rigid tubing, flexible hoses, fittings, adapters, manifolds, and/or nozzles, for example.

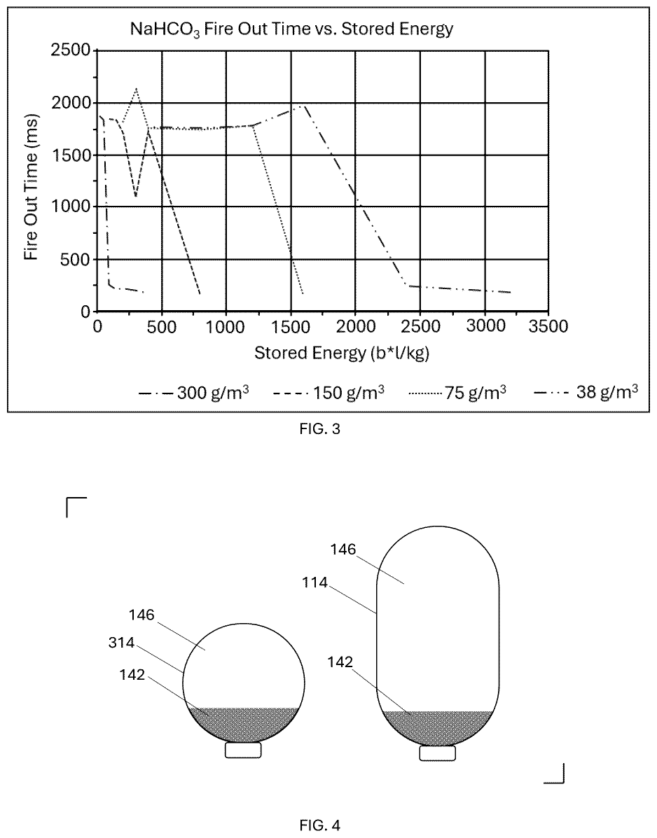

Referring to FIGS. 2 and 3, SE has been found to be a parameter to gauge how much propulsive energy a unit mass of the fire extinguishing agent 142 has in a fire extinguisher. As used herein, SE is defined as the charge pressure (i.e., pressure in the pressure vessel 114) times the volume of propellant gas 146 divided by the mass of the fire extinguishing agent 142, as shown by the equation below:

$$SE = {P}_{fill} \times \frac{{V}_{cylinder} - {V}_{a gent}}{{M}_{a gent}}$$

where SE is stored energy, P_{fill} is the fill pressure (bar) of the pressure vessel 114, V_{cylinder} is the pressure vessel's internal volume (liters), V_{agent} is the volume (liters) occupied by the agent, M_{agent} is the total mass of the agent 142 (kilograms) in the pressure vessel 114. As such, SE has the units of bar*liter/kilogram. The term cylinder, as used herein, is the term commonly used in the industry to refer to the pressure vessel 114. As such, use of the term should not be interpreted as limiting the pressure vessel 114 to a geometric cylinder. In other words, the pressure vessel 114 may be any geometric shape suitable for storing the propellant gas 146 and the agent 142.

Higher SE is realized in the form of a higher charge pressure (Pfu) and/or larger ullage (i.e., the vapor space in the pressure vessel 114) which increases the volume of propellant gas 146 per unit volume of agent 142. In the comparison shown in FIG. 2, the pressure vessel 214 is the same total volume as the pressure vessel 114. Both pressure vessels 114 and 214 are charged with the same agent 142 and propellant gas 146, to the same internal pressure. However, the pressure vessel 214 is charged with significantly more mass of the agent 142 and therefore more of the volume is occupied by the agent 142 than in pressure vessel 114. As a result, the charged pressure vessel 114 has a larger remaining free volume which is filled with a higher mass of propellant gas 146 resulting in a higher SE than the charged pressure vessel 214.

Testing revealed the result that shorter fire out times (i.e., the time to extinguish the fire) are achieved when SE is increased with reduction in agent concentration, which would be considered by the conventional wisdom in the art to be an unexpected result. This effect is best understood to be the result of increased and sustained momentum of the agent 142 in which was also shown to reduce the average particle size of the agent 142. While other system changes, including improving distribution of the agent 142 within the protected compartment 134, can improve performance, FIG. 3 shows that while holding parameters constant against a given fire threat, testing has shown that fire out times decrease as SE is increased. High SE is achieved, in part, by utilizing an extinguisher system with a pressure vessel 114 that is larger than required to hold the agent 142 alone.

In the current art (not shown), by contrast, dry chemical fire extinguishers utilize a pressure vessel that is only large enough to hold a specific mass of dry chemical agent, and the propellant gas fills the interstitial spaces between the solid particles of the agent. In the current art, the fill ratio of the dry chemical agent is generally 80-90% or higher which means that 80-90% or higher of the physical space within the pressure vessel is consumed by the solid agent when initially filled for operation. An example of a fire extinguisher with this fill ratio will utilize 5.44 kg (12 pounds) of dry chemical agent in a 4.719 L (288 in³) pressure vessel, resulting in a SE of approximately 50 bar*L/kg when charged to 51.7 bar (750 psig) with propellant gas. The common understanding in the art of dry chemical fire extinguishing is to maximize the amount of fire extinguishing agent in the pressure vessel to maximize fire extinguishing agent concentration in the protected compartment and minimize the size of the pressure vessel since the propellant gas can fill the interstitial space between the grains of agent.

The teachings of this disclosure significantly reduce the agent fill ratio of the pressure vessel to levels that conventional wisdom in the art would consider a waste of available space in the pressure vessel while increasing propellant gas charge pressure to the highest practical limit of the hardware. Counter to conventional thinking in the art, this disclosure maximizes the ratio of propellant gas 146 per unit mass of dry chemical agent 142, instead of maximizing the mass of dry chemical agent 142. Therefore, SE is maximized to propel the dry chemical agent 142 throughout the protected compartment 134. In one example, the SE is greater than or equal to 1,000 bar*L/kg. This increase in SE is also counter to conventional thinking in the art which generally seeks to lower discharge energy to reduce criteria such as impulse noise and discharge force in an occupied protected compartment.

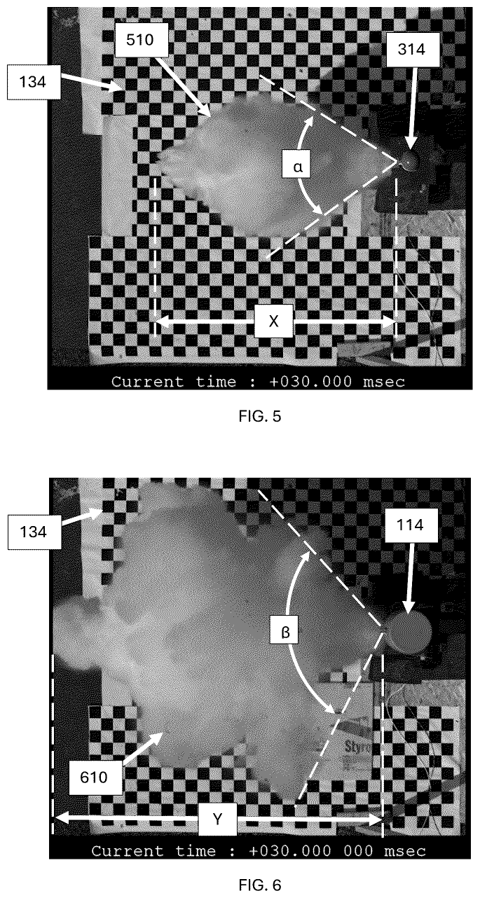

As a result of high SE, discharge times are reduced and dry chemical particle momentum is increased and retained for a longer time for improved firefighting performance, as shown in FIGS. 4-6. Referring to FIG. 4, a third pressure vessel 314 is illustrated in comparison to the pressure vessel 114 that would be used for fire extinguisher 100. The pressure vessel 314 has a smaller total internal volume than the pressure vessel 114. The pressure vessels 114 and 314 are charged with the same amount of the same agent 142 and with the same propellant gas 146 to the same pressure resulting in a higher SE for pressure vessel 114 due to larger internal volume and increased mass of propellant gas 146. FIG. 5 is a visualization of the discharge of the pressure vessel 314, taken at 30 milliseconds after opening the valve 126 (shown in FIG. 1). FIG. 6 is a visualization of the discharge of the pressure vessel 114, taken at 30 milliseconds after opening the valve 126 (shown in FIG. 1). In the examples shown in FIGS. 4-6, the pressure vessel 314 is 1.18 L (72 in³), the pressure vessel 114 is 10.9 L (665 in³), and both pressure vessels 114, 314 were charged with 0.45 kg (1 lb) of agent 142 to 75.84 bar (1,100 psi), such that the pressure vessel 314 was charged to a SE of 162 bar*L/kg and the pressure vessel 114 was charged to a SE of 1,784 bar*L/kg. As shown in FIGS. 5 and 6, the fire suppression agent 142 (visible in FIG. 5 as a cloud 510 of the agent and in FIG. 6 as a cloud 610 of the agent) is discharged at a wider angle (identified as a in FIG. 5 and β in FIG. 6) and travels further in a given time (identified as X in FIG. 5 and Y in FIG. 6) and fills a larger volume per unit time within the protected space 134 for the pressure vessel 114 of higher SE than the pressure vessel 314 of lower SE. Therefore, the firefighting performance of the pressure vessel 114 that has higher SE is found to be greater than that of the smaller pressure vessel 314 that has lower SE.

Returning to FIG. 1, the fire extinguisher system 110 of the present disclosure has control systems (e.g., the control module 118 and the valve 126) that are configured to discharge the fire extinguisher 100 fully upon detection of a fire threat. In other words, a single discharge event causes the pressure in the pressure vessel 114 to equalize with the pressure of the protected compartment 134 and release effectively all of the agent 142 from the pressure vessel 114. As such, any subsequent fire event would require recharge or additional pressure vessels (not shown) that were not used during the prior fire event. In some forms, the pressure vessel 114 can have an internal volume that ranges from 0.9 L (55 in³) to 6 L (366 in³), though other sizes can be used. It can be appreciated that further increases in SE levels will continue to improve performance. As such, FIGS. 5 and 6 illustrate the discharge patterns at a fixed time for each of the cylinders 114 and 314 shown in FIG. 4.

As shown in FIG. 8, testing has also found that high SE can break down the grains of a dry agent 142 to a smaller average particle size upon discharge than typical fire extinguishing systems. This can generally result in better fire extinguishing performance as there is more surface area of agent 142 to react with and extinguish the fire. FIG. 8 shows plots of the particle size distribution (μm) for new sodium bicarbonate (i.e., before discharge) and for sodium bicarbonate after high SE discharge. The horizontal axis indicates particle size (μm) and the vertical axis indicates volume density (%). For example, some commercially available dry chemical agents have an average particle size of approximately 31.4 μm and testing has shown that discharge under the high SE of this disclosure can reduce this average particle size down to approximately 21.3 μm. In some forms, the pressure vessel 114 can be charged with the dry chemical agent 142 having an average particle size of less than or equal to 100 μm. Commercially available dry chemical agents can be used and typically have a particle size within the range from 5 μm to 100 μm. In one non-limiting example, the pressure vessel 114 can be charged with the dry agent 142 having an average particle size of 36 μm or less. In one non-limiting example, the pressure vessel 114 can be charged with the dry agent 142 having an average particle size of approximately 31.4 μm.

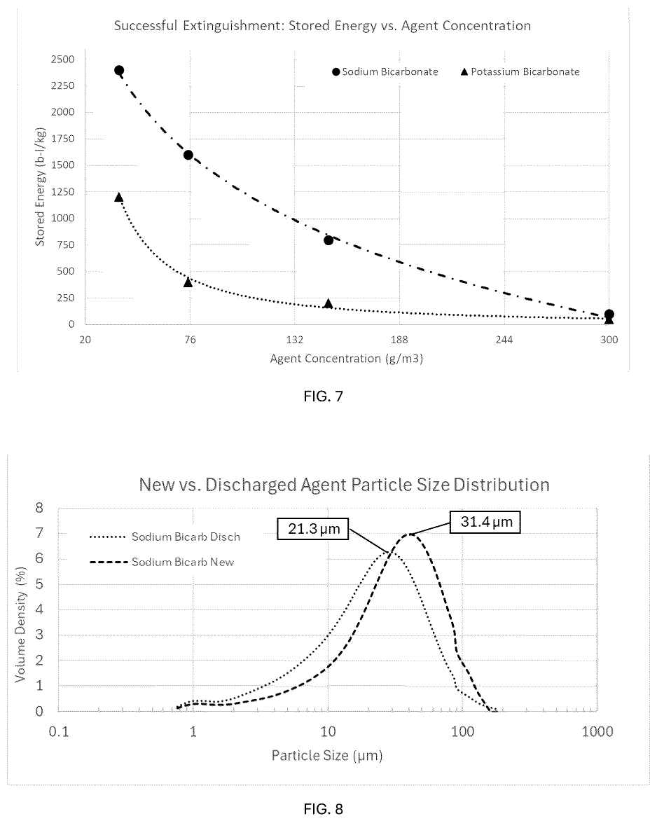

Testing revealed that fire extinguishing performance is a function of agent concentration and SE. As used herein, the agent concentration (g/m³) is defined as the mass of the agent 142 discharged in the protected compartment 134 divided by the total free air volume in the protected compartment 134, i.e., the volume of the protected compartment 134 minus the volume of any objects and/or occupants therein. For example, 454 g (1.00 lb) of dry chemical agent discharged into a free air volume equal to 5.66 m³ (200 ft³), results in an agent concentration of 80 g/m³. Test results revealed that a higher SE for a fixed agent concentration increases performance, as shown in FIG. 7, where the area above the curve of each agent indicates successful fire extinguishing for that agent. Similarly, FIG. 3 shows the fire out time significantly decreases as SE increases, for each of the agent concentrations tested. In other words, higher SE results in a lower agent concentration requirement to achieve successful extinguishment. However, space, weight and physical extinguisher pressure vessel sizes suitable for use in certain applications (e.g., on vehicles) instill a practical limit for the volume/pressure of propellant gas (P_{fill}). Utilizing a lower agent concentration at a higher SE also provides additional benefits for an occupied compartment, including minimizing visual obscuration, minimizing fire extinguishing agent inhalation risks, reduced time to clean the protected compartment of any residual agent, and lower system weight.

Testing has shown, for standard extinguisher hardware currently available for ground vehicles, success as low as a SE of 100 bar*L/kg when using 300 g/m³ agent concentration, and a SE of 2400 bar*L/kg using 38 g/m³ agent concentration, as shown in FIG. 7 for sodium bicarbonate. Potassium bicarbonate powder is generally known to be more effective than sodium bicarbonate in typical fire extinguishers and this remains true for the high SE fire extinguishers of the present invention, as reflected by the lower curve in FIG. 7.

Other tests were performed that showed successful fire extinguishing at 3,377 bar*L/kg for concentrations of sodium bicarbonate as low as 20 g/m³.

Testing was conducted at charge pressures up to 75.8 bar (1,100 psi), based on the limits of the standard extinguisher hardware. But generally, pressures in the range of 34.5 bar (500 psi) to 103.4 bar (1500 psi) are contemplated. It is understood that, if larger cylinders were used or the hardware was capable of being charged to higher pressures, then it may push the boundaries of these limits. For example, future development of extinguisher hardware (e.g., releasing valve and/or pressure vessel materials) could permit higher P_{fill}, further increasing potential SE. One such example contemplated would involve higher pressure systems and/or larger volume cylinders that can achieve SE of 5000 bar*L/kg or more when using the same agent mass.

As such, a method of extinguishing fire using the fire extinguishing system 110 can include charging the pressure vessel 114 with a fire extinguishing agent 142 (e.g., a dry chemical agent), and a propellant gas 146 to a SE as discussed above with reference to the fire extinguishing system 110. The method may include detecting a fire threat in a protected compartment and fully discharging the pressure vessel into the protected compartment in response to detecting the fire, as discussed above with reference to the fire extinguishing system 110. The fire threat may be detected using one or more sensors in communication with a control module, as discussed above with reference to the fire extinguishing system 110. As also discussed above with reference to the fire extinguishing system 110, the control module is configured to fully discharge the pressure vessel into the protected compartment, such as by sending a signal to the valve to open the valve.

The dry chemical agents may include various types and compositions of dry chemicals in a granularized form (e.g., a powder). Some examples of dry chemical agents used with the teachings of the present disclosure include sodium bicarbonate (NaHCO₃) or potassium bicarbonate (KHCO₃), though other dry chemical agents can be used. In one form, the charge or propellant gas is an inert gas, such as nitrogen (N₂), though other gases can be used.

Additionally, increased stored energies can increase the performance of other non-dry chemical fire extinguishing agents including aqueous and gaseous (e.g., halons or HFCs etc.). As such, in an alternative configuration, the agent 142 may be a non-dry chemical fire extinguishing agent.

According to the teachings of the present disclosure, higher SE has been shown to allow lower concentration of agent to achieve improved fire extinguishing performance. Benefits of this approach include reduced visual obscuration, less cleanup of residual agent post discharge, lower inhalation risks, and lower system weight over traditional fire extinguishing systems.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, including the definitions below, the term “module” or the term “controller” may be replaced with the term “circuit”. The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

What is claimed is:

1. A fire extinguishing system comprising:
a pressure vessel charged with a predetermined mixture to a stored energy of greater than 100 bar*L/kg, the predetermined mixture including a propellant gas and a fire extinguishing agent;
a control module configured to fully discharge the pressure vessel to a protected compartment in response to a fire threat detected in the protected compartment by at least one sensor in communication with the control module.

2. The fire extinguishing system according to claim 1, further comprising a valve coupled for fluid communication with an outlet of the pressure vessel, wherein the controller is configured to change the valve from a closed state to an open state to fully discharge the pressure vessel to the protected compartment in response to the fire threat detected in the protected compartment by the at least one sensor.

3. The fire extinguishing system according to claim 2, further comprising:
a conduit in fluid communication with the outlet of the pressure vessel and configured to convey the fire extinguishing agent to the protected compartment.

4. The fire extinguishing system according to claim 2, further comprising the protected compartment, wherein the protected compartment is an occupant compartment of a vehicle.

5. The fire extinguishing system according to claim 4, wherein a ratio of the fire extinguishing agent in the predetermined mixture to a total free air volume of the protected compartment is within the range from 20 g/m³ to 300 g/m³.

6. The fire extinguishing system according to claim 1, wherein the fire extinguishing agent is a dry chemical agent.

7. The fire extinguishing system according to claim 6, wherein the fire extinguishing agent consists essentially of sodium bicarbonate, potassium bicarbonate, or a combination of sodium bicarbonate and potassium bicarbonate.

8. The fire extinguishing system according to claim 6, wherein the dry chemical agent has an average particle size less than or equal to 36 μm.

9. The fire extinguishing system according to claim 1, wherein the predetermined mixture consists of the propellant gas and the fire extinguishing agent, wherein the propellant gas consists essentially of inert gas, wherein the fire extinguishing agent is a dry chemical agent consisting essentially of sodium bicarbonate, potassium bicarbonate, or a combination of sodium bicarbonate and potassium bicarbonate.

10. The fire extinguishing system according to claim 1, wherein the propellant gas consists essentially of inert gas.

11. The fire extinguishing system according to claim 1, wherein the stored energy is greater than 1,000 bar*L/kg.

12. The fire extinguishing system according to claim 1, wherein the pressure vessel has an internal volume in the range of 0.9 L to 6 L.

13. A fire extinguishing system comprising:
a pressure vessel charged with a predetermined mixture to a stored energy of greater than 100 bar*L/kg, the predetermined mixture consisting of a propellant gas and a dry chemical agent;
at least one sensor; and
a control module configured to fully discharge the pressure vessel to a protected compartment in response to a fire threat detected in the protected compartment by the at least one sensor.

14. The fire extinguishing system according to claim 13, wherein the propellant gas consists essentially of inert gas, wherein the dry chemical agent is a powder that consists essentially of sodium bicarbonate, potassium bicarbonate, or a combination of sodium bicarbonate and potassium bicarbonate.

15. The fire extinguishing system according to claim 14, wherein the dry chemical agent has an average particle size less than or equal to 36 μm.

16. The fire extinguishing system according to claim 13, further comprising the protected compartment, wherein the protected compartment is an occupant compartment of a vehicle, and wherein a ratio of the dry chemical agent in the predetermined mixture to a total free air volume of the protected compartment is less than or equal to 300 g/m³.

17. The fire extinguishing system according to claim 13, wherein the stored energy is greater than 1,000 bar*L/kg.

18. A method of extinguishing fire in a protected compartment comprising:
charging a pressure vessel with a predetermined mixture to a stored energy of greater than 100 bar*L/kg, the predetermined mixture including a propellant gas and a fire extinguishing agent;
detecting a fire threat using at least one sensor; and
fully discharging the pressure vessel to the protected compartment in response to the fire threat being detected by the at least one sensor.

19. The method according to claim 18, wherein the predetermined mixture consists of the propellant gas and the fire extinguishing agent, wherein the fire extinguishing agent is a dry chemical agent, wherein the propellant gas consists essentially of inert gas, wherein the dry chemical agent consists essentially of sodium bicarbonate, potassium bicarbonate, or a combination of sodium bicarbonate and potassium bicarbonate.

20. The method according to claim 19, wherein the stored energy is greater than or equal to 1,000 bar*L/kg.
